(19) United States
(12) Patent Application Publication
(10) Pub. No.: US 2013/0187535 A1
(43) Pub. Date: Jul. 25, 2013

(54) LED Lamp

(71) Applicant: MAINHOUSE (XIAMEN) ELECTRONICS CO., LTD, Fujian (CN)

(72) Inventor: Nan-Qing ZHOU, Fujian (CN)

(73) Assignee: MAINHOUSE (XIAMEN) ELECTRONICS CO., LTD., Fujian (CN)

(21) Appl. No.: 13/794,745

(22) Filed: Mar. 11, 2013

Related U.S. Application Data
(63) Continuation-in-part of application No. 13/030,236, filed on Feb. 18, 2011.

(30) Foreign Application Priority Data
Jan. 7, 2010 (CN) 201020249911.5

(51) Int. Cl. H05B 33/22

(52) U.S. Cl. CPC H05B 33/22
USPC 313/498

(57) ABSTRACT

An LED lamp includes a lamp body, a reflecting cup disposed at an outer side of the main body and a fixing seat extending from a bottom of the reflecting cup. The fixing seat has at least one inclined surface which is disposed at an angle in the range of 1 degree to 30 degrees with respect to the axis of the LED lamp. A lighting member is provided on the at least one inclined surface. The light is not emitted at a right angle so the light is not harsh to the eyes. Besides, the LED is not installed on an upright surface, which can reduce the light to be blocked. The inclined surface is disposed at an angle in the range of 1 degree to 30 degrees with respect to the axis of the lamp. This arrangement can avoid a larger dark area because of a smaller angle and avoid increasing the direct light range because of a larger angle. The light of the lamp can be reflected effectively.

### BACKGROUND OF THE INVENTION

1. Field of the Invention

The present invention is a Continuation in Part of U.S. application Ser. No. 13,030236, and claims the domestic priority filing date of Feb. 18, 2011, which claimed the foreign priority filing date of CN 201020249911.5, filed on Jul. 1, 2010.

The present invention relates to an LED lamp.

2. Description of the Prior Art

As shown in FIG. 1, a conventional lamp comprises a lighting member installed at the bottom of a reflecting cup. When the lamp is lightened, most light of the lighting member is direct emitted from the lamp, only little light is reflected through the reflecting cup. The light of the lighting member of this lamp is radiated direct, which is harsh to the eyes when the user looks at the light. Some high-power lighting members have harsh light which may hurt the user's eyes.

As shown in FIG. 2, another improved lamp comprises a reflecting cup and a lighting member disposed on a side of an upright pole extending out from the bottom of the reflecting cup. The lighting member emits light on the reflecting cup and then the reflecting cup reflects the light. The kind of lamp doesn't have harsh light, but some light is blocked by the pole. The illumination of this lamp is not good, and there may be a dark area at the center of the illuminating area.

U.S. Pat. No. 7,048,412 B2 discloses a LED lamp, which comprises a pole extending from the bottom of a lamp base. An LED is installed on the side of the pole. In FIG. 16 and FIG. 18 of this patent, the pole is a conical or pyramid cylinder. The lighting surface of the LED is almost perpendicular to the axis of the lamp.

The conical or pyramid cylinder increases its cross-section to dissipate heat. The installation way of the LED causes that some light is blocked to influence the illumination effect.

### SUMMARY OF THE INVENTION

The primary object of the present invention is to provide an LED lamp. The LED lamp provides even light which is not harsh to the eyes.

In order to solve the aforesaid questions, the present invention relates to an LED lamp and comprises a lamp body, a reflecting cup disposed at an outer side of the main body and a fixing seat extending from a bottom of the reflecting cup. The fixing seat has at least one inclined surface which is disposed at an angle in the range of 1 degree to 30 degrees with respect to the axis of the LED lamp. A lighting member is provided on the at least one inclined surface.

In particular, the fixing seat, extended from a bottom of the reflecting cup, further including a fixing disk, concentrically secured over a bottom disk, with a diameter thereof no greater than that of the bottom disk, two or more fixing edges, extended from an outer periphery of the fixing disk and parallel to a central axis of the LED lamp, and a plurality of inclined surfaces, with no edge thereof parallel to the diameter of the fixing disk, stemming from a base of the fixing disk and way from the central axis of the LED lamp, slantingly towards the central axis at a fixed angle in the range of 1 to 30 degrees with respect to the central axis of the LED lamp, and extending for forming a height of the fixing seat, with two edges of each of the inclined surfaces affixing the two or more fixing edges respectively.

Preferably, the fixing seat has a plurality of inclined surfaces which are equally disposed around the axis of the LED lamp.

Preferably, a cap is provided under the fixing seat.

Preferably, the reflecting cup has a reflecting surface which is composed of a plurality of minor faced planes.

Preferably, a light hood is provided under the reflecting cup and the light hood has a side wall which is disposed at a certain angle.

Preferably, the light hood is movably connected to the reflecting cup.

Preferably, the light hood has a plurality of ribs on an inner side thereof and the reflecting cup has corresponding L-shaped engaging recesses on an outer wall thereof.

Alternatively, the light hood has inner threads on an inner side thereof, the reflecting cup has outer threads on an outer wall thereof, and the light hood is connected to the reflecting cup through the inner threads and the outer threads.

The lighting member of the present invention is installed on the inclined surface which has an angle with respect to the axis of the lamp. When the lamp is lightened, the lighting member will emit light toward the reflecting cup and then the light will be reflected through the reflecting cup. The light is not emitted at a right angle so the light is not harsh to the eyes. Besides, the lighting member is not installed on an upright surface, which can reduce the light to be blocked.

The inclined surface is disposed at an angle in the range of 1 degree to 30 degrees with respect to the axis of the lamp. This arrangement can avoid a larger dark area because of a smaller angle and avoid increasing the direct light range because of a larger angle. The light of the lamp can be reflected effectively.

The fixing seat may have a plurality of inclined surfaces which are equally disposed around the axis of the lamp. Each surface is provided with one lighting member so that the light is more even and softer.

Furthermore, a light hood is provided under the reflecting cup. The light hood is used to change the projecting area of the light for centering the light.

### BRIEF DESCRIPTION OF THE DRAWINGS

FIG. 1 is a schematic view showing the light of a conventional lamp;

FIG. 2 is a schematic view showing the light of another conventional lamp;

FIG. 3 is a perspective view according to a first embodiment of the present invention;

FIG. 4 is a cross-sectional view according to the first embodiment of the present invention;

FIG. 5 is a schematic view showing the light of the lighting member according to the first embodiment of the present invention;

FIG. 6 is a cross-sectional view taken along line A-A of FIG. 4;

FIG. 7 is a perspective view according to a second embodiment of the present invention;

FIG. 8 is a cross-sectional view according to the second embodiment of the present invention;

FIG. 9 is a cross-sectional view taken along line B-B of FIG. 8;

FIG. 10 is a cross-sectional view according to a third embodiment of the present invention;

FIG. 11 is an exploded view according to the third embodiment of the present invention;

FIG. 12 is a cross-sectional view according to a fourth embodiment of the present invention;

FIG. 13 is an exploded view according to the fourth embodiment of the present invention;

FIG. 14 is a cross-sectional view according to a fifth embodiment of the present invention; and

FIG. 15 is an exploded view according to the fifth embodiment of the present invention.

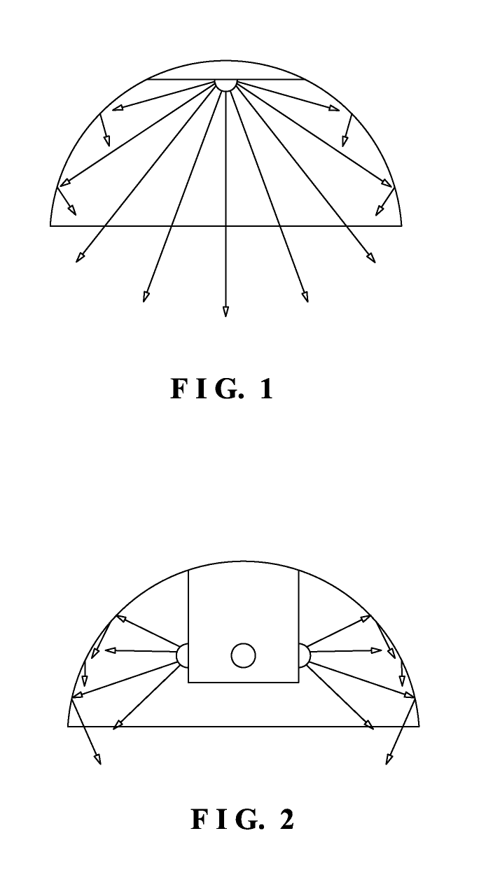

### DETAILED DESCRIPTION OF THE PREFERRED EMBODIMENTS

Embodiments of the present invention will now be described, by way of example only, with reference to the accompanying drawings.

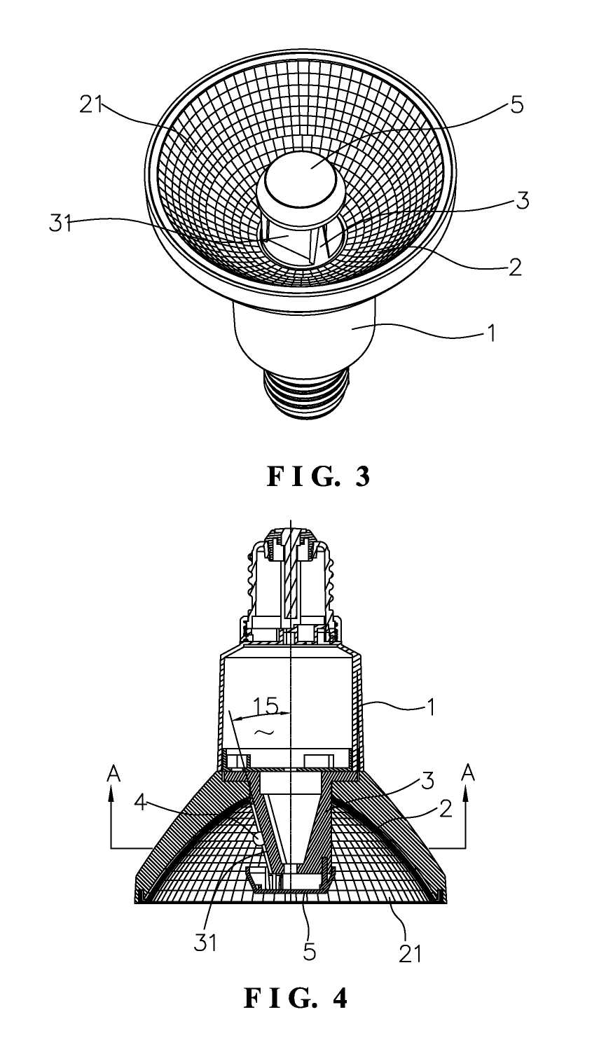

As shown in FIG. 3 and FIG. 4, an LED lamp according to a first embodiment of the present invention comprises a lamp body 1, a reflecting cup 2 disposed at an outer side of the main body 1, and a fixing seat 3 extending from a bottom of the reflecting cup 2. The fixing seat 3 has at least one inclined surface 31 which is disposed at an angle in the range of 1 degree to 30 degrees with respect to the axis of the LED lamp. A light emitting diode (LED) 4 is provided on the at least one inclined surface 31.

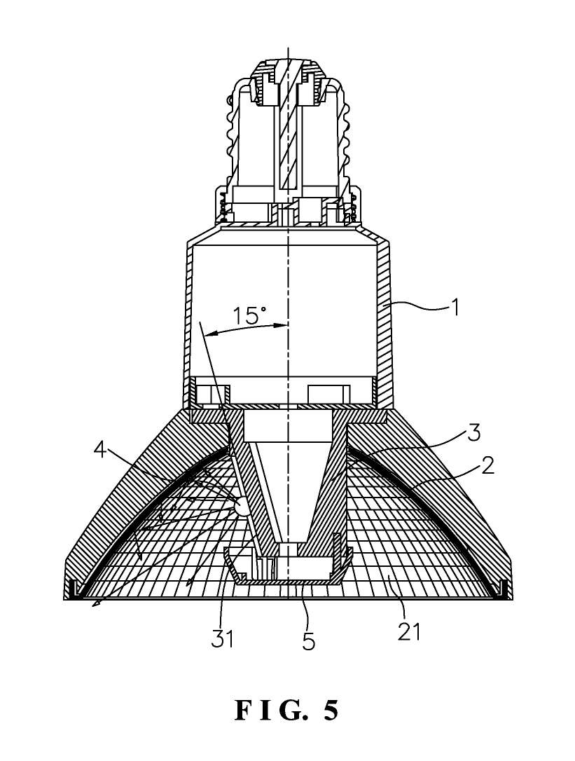

The LED 4 is installed on the inclined surface 31 which has an angle with respect to the axis of the lamp. When the lamp is lightened, the LED 4 will emit light toward the reflecting cup 2 and then the light will be reflected through the reflecting cup 2. As shown in FIG. 5, the light is not emitted at a right angle so the light is not harsh to the eyes. Besides, the LED is not installed on an upright surface, which can reduce the light to be blocked.

Furthermore, the inclined surface 31 is disposed at an angle in the range of 1 degree to 30 degrees with respect to the axis of the lamp. This arrangement can avoid a larger dark area because of a smaller angle and avoid increasing the direct light range because of a larger angle. The light of the lamp can be reflected effectively.

Nowadays, chips are well developed to enhance the radiation efficiency of an LED. The LED lamp of the present invention only needs a LED chip on each surface to achieve the desired light.

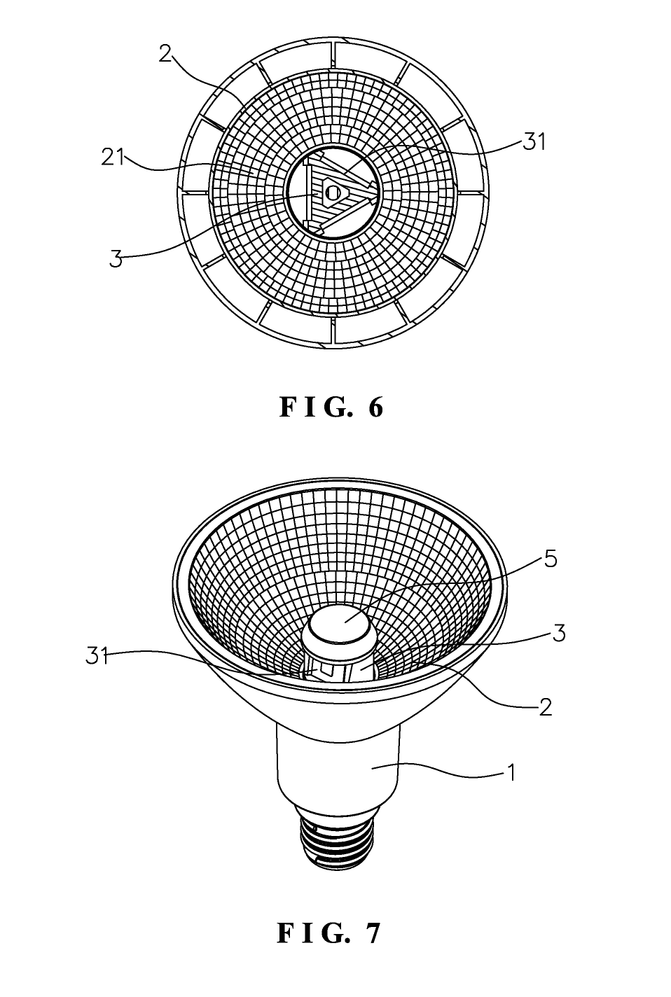

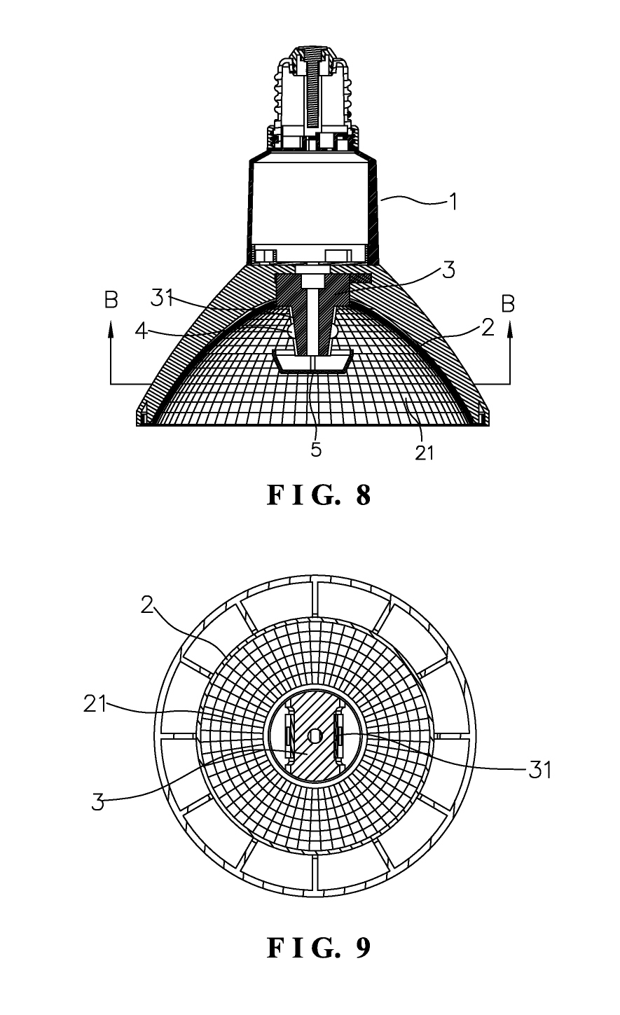

In order to get even light, the fixing seat 3 may have a plurality of inclined surfaces 31 which are equally disposed around the axis of the lamp. As shown in FIG. 6, in this embodiment the fixing seat 3 has three inclined surfaces 31. Each surface 31 is provided with one LED 4. In this way, the light is more even and softer. FIG. 7 and FIG. 8 show a second embodiment of the present invention. In this embodiment, the fixing seat 3 has two symmetrical inclined surfaces 31, which also provides even light.

The reflecting cup 2 has a reflecting surface which is composed of a plurality of minor faced planes 21. This reduces the reflecting area of each plane, preventing a larger reflecting facula area, so the light is softer and more comfortable.

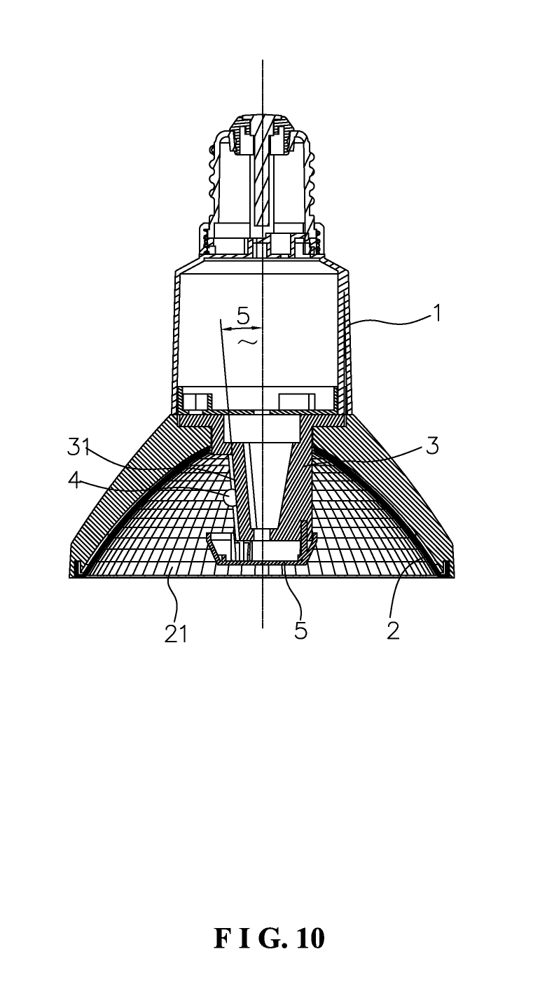

It is noted that the inclined surface 31 can be disposed at a desired angle in the range of 1 degree to 30 degrees with respect to the axis of the lamp. As shown in FIG. 4, the inclined surface 31 is disposed at 15 degrees with respect to the axis of the lamp in the first embodiment. FIG. 10 shows a third embodiment of the present invention. The inclined surface 31 is disposed at 5 degrees with respect to the axis of the lamp. The angle is not more than 30 degrees. The smaller the angle is, the better the illumination is.

In particular, the fixing seat, extended from a bottom of the reflecting cup, further including a fixing disk, concentrically secured over a bottom disk, with a diameter thereof no greater than that of the bottom disk, two or more fixing edges, extended from an outer periphery of the fixing disk and parallel to a central axis of the LED lamp, and a plurality of inclined surfaces, with no edge thereof parallel to the diameter of the fixing disk, stemming from a base of the fixing disk and way from the central axis of the LED lamp, slantingly towards the central axis at a fixed angle in the range of 1 to 30 degrees with respect to the central axis of the LED lamp, and extending for forming a height of the fixing seat, with two edges of each of the inclined surfaces affixing the two or more fixing edges respectively.

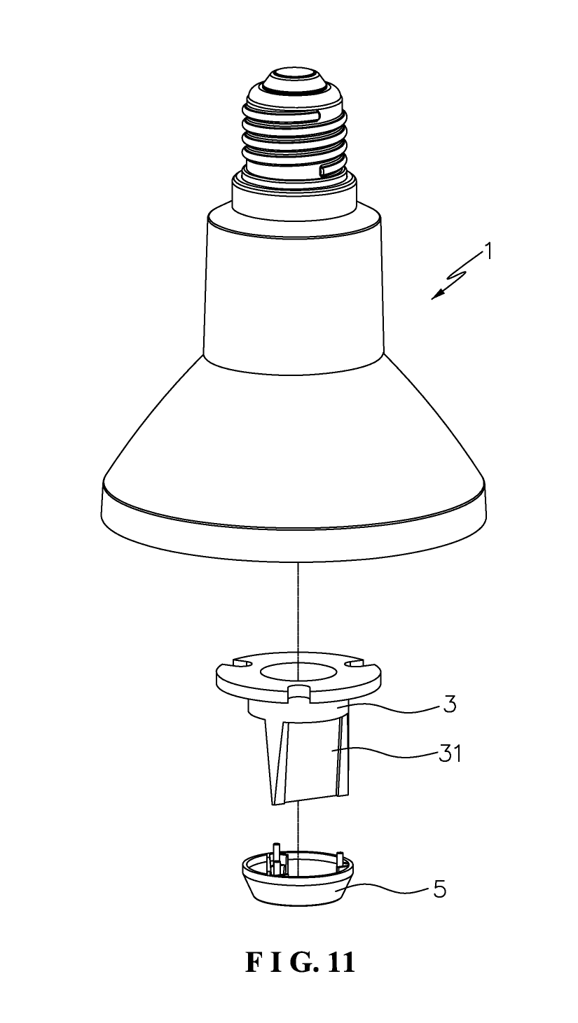

Referring to FIG. 10 and FIG. 11, the present invention further comprises a cap 5 which is disposed under the fixing seat 3 to shelter the LED 4, preventing the light from being emitted direct.

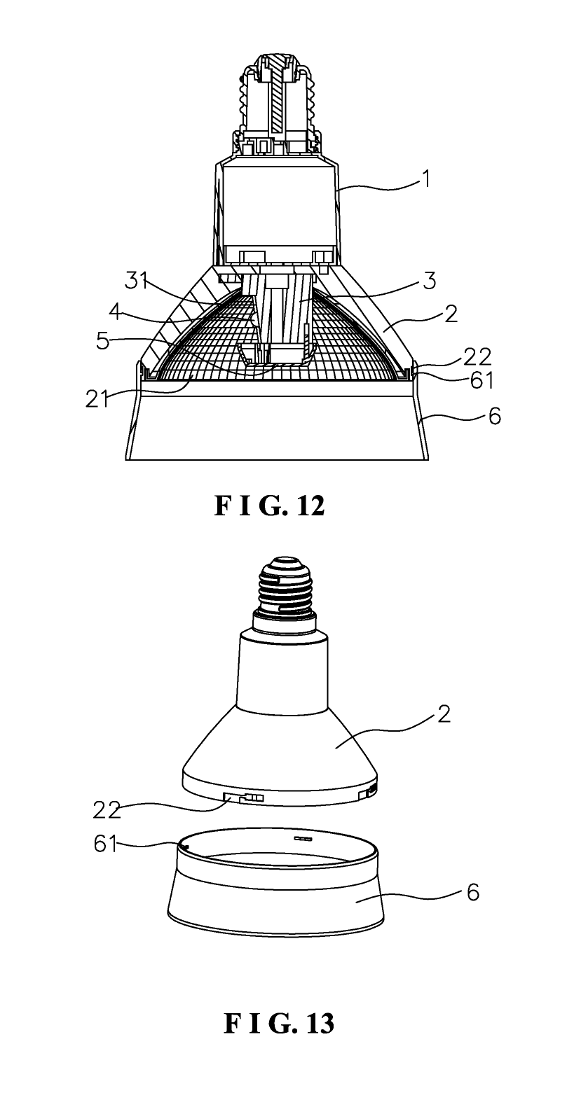

FIG. 12 and FIG. 13 show a fourth embodiment of the present invention. The LED lamp comprises a lamp body 1, a reflecting cup 2 disposed at an outer side of the main body 1, and a fixing seat 3 extending from a bottom of the reflecting cup 2. The fixing seat 3 has three inclined surfaces 31. Each inclined surface 31 is disposed at an angle in the range of 1 degree to 30 degrees with respect to the axis of the LED lamp. A light emitting diode (LED) 4 is provided on each inclined surface 31. A light hood 6 is provided under the reflecting cup 2. The light hood 6 has a side wall which is disposed at a certain angle. The light hood 6 is used to change the projecting area of the light for centering the light.

The light hood 6 is movably connected to the reflecting cup 2. As shown in FIG. 12 and FIG. 13, the light hood 6 has a plurality of ribs 61 on an inner side thereof. The reflecting cup 2 has corresponding L-shaped engaging recesses 22 on an outer wall thereof. The light hood 6 is connected to the reflecting up 2 by the ribs 61 to engage with the L-shaped engaging recesses 22.

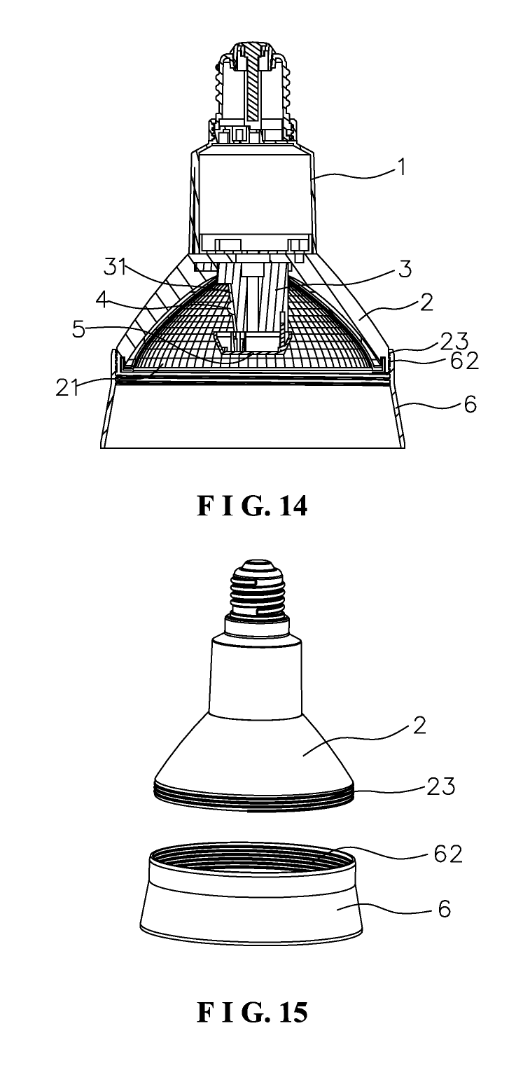

FIG. 14 and FIG. 15 show a fifth embodiment of the present invention. In this embodiment, the light hood 6 has inner threads 62 on an inner side thereof. The reflecting cup 2 has outer threads 23 on an outer wall thereof. The light hood 6 is connected to the reflecting cup 2 through the inner threads 62 and the outer threads 23.

Although particular embodiments of the present invention have been described in detail for purposes of illustration, various modifications and enhancements may be made without departing from the spirit and scope of the present invention. Accordingly, the present invention is not to be limited except as by the appended claims.

1. A light emitting diode (LED) lamp, comprising
a lamp body,
a reflecting cup,
a fixing seat, extended from a bottom of the reflecting cup, further including
a fixing disk, concentrically secured over a bottom disk, with a diameter thereof no greater than that of the bottom disk,
two or more fixing edges, extended from an outer periphery of the fixing disk and parallel to a central axis of the LED lamp, and
a plurality of inclined surfaces, with no edge thereof parallel to the diameter of the fixing disk, stemming from a base of the fixing disk and away from the central axis of the LED lamp, slantingly towards the central axis at a fixed angle in the range of 1 to 30 degrees with respect to the central axis of the LED lamp, and extending for forming a height of the fixing seat, with two edges of each of the inclined surfaces affixing the two or more fixing edges respectively; and
a lighting member being provided on the inclined surfaces.

2. The LED lamp as claimed in claim 1, wherein the inclined surfaces are equidistantly disposed around the central axis of the LED lamp.

3. The LED lamp as claimed in claim 1, wherein a cap is provided under the fixing seat.

4. The LED lamp as claimed in claim 1, wherein the reflecting cup has a reflecting surface composed of a plurality of minor faced planes.

5. The LED lamp as claimed in claim 1, wherein a light hood is provided under the reflecting cup and the light hood has a side wall which is disposed at a certain angle.

6. The LED lamp as claimed in claim 5, wherein the light hood is movably connected to the reflecting cup.

7. The LED lamp as claimed in claim 6, wherein the light hood has a plurality of ribs on an inner side thereof and the reflecting cup has corresponding L-shaped engaging recesses on an outer wall thereof.

8. The LED lamp as claimed in claim 6, wherein the light hood has inner threads on an inner side thereof, the reflecting cup has outer threads on an outer wall thereof, and the light hood is connected to the reflecting cup through the inner threads and the outer threads.
